(19) United States
(12) Patent Application Publication
(10) Pub. No.: US 2012/0290363 A1
(43) Pub. Date: Nov. 15, 2012

(54) METHOD OF MONITORING SUSTAINABILITY OF BIOPRODUCTS

(75) Inventors: Ricardo ARJONA ANTOLIN, Sevilla (ES); María de las Nieves VALENZUELA ROMERO, Sevilla (ES); Beatriz ALONSO MARTINEZ, Madrid (ES); Raquel DIAZ MOLIST, Madrid (ES); Rocío GARCIA ENCINAS, Sevilla (ES); Maria Angeles GUTIERREZ MONTERO, Sevilla (ES); Jesus YANEZ VIDAL, Sevilla (ES); Laura MONTES GARCIA, Sevilla (ES); Jesus LOPEZ LOPEZ, Sevilla (ES); Macarena MARQUEZ PINUELA, Sevilla (ES); Marta VAZQUEZ GARCIA, Sarriguren (ES)

(73) Assignee: ABENGOA BIOENERGIA NUEVAS TECNOLOGIAS, S.A., Sevilla (ES)

(21) Appl. No.: 13/467,647

(22) Filed: May 9, 2012

Related U.S. Application Data
(63) Continuation-in-part of application No. 13/103,331, filed on May 9, 2011.
Application No. 13/103,331 is a continuation-in-part of application No. 13/103,525, filed on May 9, 2011.
Application No. 13/103,525 is a continuation-in-part of application No. 13/103,555, filed on May 9, 2011.

(51) Int. Cl. G06K 9/00; G06Q 10/00

(52) U.S. Cl. 705/7.38; 382/110

(57) ABSTRACT

Described herein is a method of monitoring the origin and composition of bioproducts such as biofuels that are the result of mixing more than one type of biofuel, thereby ensuring that a particular bioproduct presents a certain amount of a particular type of each bioproduct with corresponding emissions related data and sustainability.

### CROSS-REFERENCE TO RELATED APPLICATIONS

This application is a continuation-in-part of U.S. Non-Provisional patent application Ser. Nos. 13/103,331, 13/103,525, and 13/103,555, all filed May 9, 2011, which are hereby incorporated herein by reference in their entireties for all purposes.

### OBJECT OF THE INVENTION

The present invention relates to the field of sustainability and biofuels, but is extended to any kind of byproduct.

The main object of the invention is a method for determining the level of sustainability (which term is detailed along the specification) of a given once bioproduct produced thereby establishing different types thereof as few scales determined easily identifiable.

### BACKGROUND OF THE INVENTION

It is now well known that the global climate is being altered significantly as a result of increased concentrations of greenhouse gases such as carbon dioxide, methane, nitrous oxides and chlorofluorocarbons. These gases are trapping an increasing proportion of terrestrial infrared radiation and are expected to increase global temperatures (so-called Greenhouse Effect and Global Warming). Thus the great importance that are currently taking any initiative for the use of bioproducts, and more particularly biofuels. It should be noted that the term “bio” includes building materials, pulp and paper, forest products, biofuels, bio-ethanol based on cellulose and starch-based, adhesives based on biological, biochemical, bioplastics, etc. The byproducts are active subjects of research and development, and these efforts have developed significantly in the transition Century 20/21, driven mainly by the environmental impact of oil use. The bio-derived bio can replace most of the fuel, chemicals, plastics, etc. currently derived from petroleum. For example, bioenergy is the kind of byproduct which provides a renewable source of energy available from materials derived from biological sources.

These bioproducts used as a real alternative must be sustainable. For sustainable bioproducts, ensure that both the origin of raw materials and transforming them is sustainable, but on-site verification is very difficult.

As an example of byproduct, biofuels have attracted the attention of scientists and the general public, influenced by factors such as increasing oil prices, the need for increased energy security and concerns about emissions of greenhouse gas fossil fuels. Biofuels are used inter alia for the production of ETBE (gasoline additive), or for direct blending with gasoline or diesel. As renewable energy sources, biofuels reduce CO2 emissions and contribute to the security and diversification of energy supply, while reducing dependence on fossil fuels in transportation and help in implementing the Kyoto Protocol.

In order to produce the byproduct, such as biofuels like ethanol and biodiesel, are needed to carry out some processes, these processes produce emissions such as greenhouse gases (GHGs).

Greenhouse gases (GHG) are gases in the atmosphere that absorb and emit radiation within the thermal infrared range which is the root cause of the greenhouse effect. The main greenhouse gases in the earth's atmosphere are carbon dioxide, methane, nitrous oxide, among others.

The bioproducts have been promoted as a climate solution as well as for its energy security and domestic economic benefits, analysts often assume that, unlike emissions from the bio-processes do not emit CO2 as their net biogenic carbon has been absorbed recently the atmosphere.

Therefore, it seems clear that you can use byproducts as an alternative to other fossil fuel derived thereby producing less greenhouse gases, but we must know how GHG emissions are involved in the production of these byproducts in order to determine whether the use byproduct instead of other fossil fuels could benefit from reduced emissions affecting global warming, thus needing to be able to accurately calculate GHG emission level associated with the entire process of producing the byproduct, i.e. the level of emissions GHG emissions resulting from GHG associated with each individual process used for the transformation of raw materials.

In this respect are found in various prior art documents such as the U.S. claims U.S. 2009/287520 which describes a system for determination of greenhouse gas GHG resulting from the use of coal as a renewable fuel for energy production to replace of a fossil fuel, U.S. 2008/195329 which describes a method and system for detection, quantification or characterization of the sources that emit greenhouse where the source of emission is monitored by the control of an area that has a number of sensors, U.S. 2003/120444 and U.S. 2009/303058.

Also in the sale storage and distribution of bioproducts such as biofuels is desirable to determine and to inform potential customers and/or distributors how sustainable is the byproduct that is being distributed. The European framework states that the sustainability criteria will only be effective if they can quantify and assess biofuels and bioliquids (bioproducts) that meet these criteria, compared with products that do not. According to mass balance method for verifying compliance, there is a physical link between the production of biofuels and bioliquids meeting the sustainability criteria and the use of biofuels and bioliquids in the European Community.

This link is given by the concept of mass balance where the sum of all the masses that enter a process or operation must be equal to the sum of all masses result of that process or operation.

Therefore, to ensure that biofuels and bioliquids byproducts as meeting the sustainability criteria can have real value and significant added value, the mass balance method be used to verify these conditions.

The technical problem posed here is to provide a method to monitor the sustainability of a bioproduct issued by applying mass balance calculations and to obtain data necessary to calculate the mass balance in products that are easily measurable because they do not come in lots, for example flows of fuel, it is necessary to obtain data related to geographical areas of production of raw materials, processing of these and possibly if it is necessary logistics associated with it.

### DESCRIPTION OF THE INVENTION

The present invention overcomes the aforementioned disadvantages by providing a method which has facilitated the calculation of mass balances defined properly and also mix the raw materials or items such as biofuels bioproducts with differing sustainability characteristics, information on the sustainability characteristics and sizes of the consignments referred each to remain assigned to the mix, and provides for the sum of all consignments withdrawn from the mixture has the same sustainability characteristics, in the same quantities that the sum of all items added to the mixture.

To carry out such a method is implemented using remote sensing data collection that identifies, geotag and define places of production of raw materials into bioproducts, such geographic areas considered to be sustainable for the production of materials intended for the production of bioproducts are determined as such by remote detection techniques, more specifically, this method is particularly applicable to identify those areas that meet predefined sustainability requirements. These sustainability requirements state that materials intended for processing into bio should not be made from land with high biodiversity, carbon stocks or other peat lands, and additionally take into account the land use requirement mentioned above and others requirements.

The invention described herein are as sustainability requirements may require those raw materials or plant production and processing of such materials in bioproduct, being among the first: the requirement of biodiversity, the reserve requirement carbon, and the requirement of peat.

The requirement of biodiversity is related to forests and other wooded land, namely forest and other wooded land of native species where there are no clearly visible indications of human activity and ecological processes are not significantly disrupted. Designated areas, which are areas designated by law or by important authorities for the purpose of nature protection, or protection of rare, endangered or threatened species recognized by agreements or admissions, or included in lists drawn up by intergovernmental organizations such as International Union for Conservation of Nature (IUCN). It also includes grassland with a rich natural biodiversity: namely, grasslands remain so in the absence of human intervention and which maintains the natural species composition and ecological characteristics and processes; or unnatural: namely that they would stop grazing be in the absence of human intervention and which are rich in species and not degraded. To all this applies a number of exceptions such as nature protection areas: it provides evidence that the production of raw materials does not interfere with the purposes of protecting nature.

As for the requirement of carbon stocks, wetlands are considered: namely, land that is covered or saturated with water permanently or for a significant part of the year, continuously forested areas, namely land spanning more one hectare with trees higher than 5 meters in height and canopy cover over 30% or trees able to reach these thresholds in situ. This does not include land that is predominantly under agricultural or urban land use, land spanning more than one hectare with trees higher than 5 meters and a canopy cover between a given range, or trees able to reach those thresholds in situ, unless evidence is provided. To all this a number of exceptions applies the provisions of this paragraph shall not apply if, at the moment you have the raw materials, land has the same status it has had on a specific date before.

Finally, the requirement of peat corresponds with the raw materials for the production of bioproducts should not be made from land that was peat land in a specific date before. To all this applies a number of exceptions such as when providing evidence that the production and harvesting of the raw material does not involve drainage of previously undrained soil or the soil is completely drained in a particular year or that there has been no drainage soil from a particular date before.

To all this you can add the requirement of land use change (LUC requirement): refers to the need to minimize greenhouse gas emissions caused by changes in land use from a particular year. The land use change must be understood in reference to changes in terms of ground cover six categories of land used by the IPCC (land for forests, rangeland, cropland, wetlands, settlements and other land) plus seventh perennial crop category. To all this applies to a number of exceptions as a change from one crop to another is not considered land use change, which includes fallow agricultural land (land left fallow for one or more years before being cultivated. Changes in management activities, tillage practice or practice of composting action are not considered land use change.

The whole method is preferably carried out by a computer program for monitoring sustainability of bioproducts, the program itself comprises various instructions which should be processed and run by processing unit, local or remote being the program allocated on a physical data carrier and being at least database accessible by said processing unit; said instructions are intended for:
retrieving data related to GHG emissions produced during the production of raw material to be transformed into bioproduct,
capturing geotagged images of at least one area where the raw material is produced,
processing said images in order to image processing by at least one processing unit of the captured images, to define and establish the area of production of raw material to be transformed into bioproduct,
calculating data regarding GHG emission levels for each process related to raw material production and logistics and processing and logistics related to the transformed bioproduct respectively associated with each of these processes,
establish sustainability characteristics of raw material, transformed bioproduct and associated logistics according to a definite correlation between sustainability and data regarding GHG emission levels which states that the lower level greater sustainability, wherein said sustainability characteristics comprises at least one of the following:
   sustainability characteristics of the raw material-related data regarding GHG emission levels produced during production of raw material in the geographical area,
   sustainability characteristics of the processing plant data regarding GHG emission levels produced in the processing plant where the raw material is transformed in bioproduct, and
   sustainability characteristics related to logistics, from data regarding GHG emission levels produced in logistics associated to the carriage of the raw material and the distribution of the transformed bioproduct,
assigning each bioproduct relevant sustainability characteristics depending on the geographical area of production of raw material from which it is produced, the processing plant where it was produced and used in the transportation logistics of raw material to the plant and final bioproduct distribution, and
calculating the respective quantities of each first and second bioproduct processed in the processing plant, and the composition of the bioproduct end where the calculation includes data relating to quantities of first and second mixed bioproduct as the relevant sustainability characteristics that make up each component of the final bioproduct.

The computer program is also related to a computer-implemented business model data management method, the business model is related to a final market value of the produced bioproduct depending on the sustainability level of said bioproduct which might be useful to establish a final market value of the produced bioproduct depending on the sustainability level of said bioproduct. The method has a set of instructions comprising amongst others: retrieving data related to GHG emissions produced during the production of raw material to be transformed into bioproduct and its transformation and associated logistics to both processes and any task involved, defining and establish the area of production of raw material to be transformed into bioproduct, locating data management rules related to sustainability level in the database; and correlating said sustainability level with a business object, wherein said business object is related to a business application associated to a bioproduct obtained from raw material, and executing said located data management rules to represent said identified business object in a database for said business application.

The rules related to sustainability level used for the computer method, either the business model or the method itself, may comprise characteristics of raw material, transformed bioproduct and associated logistics according to a definite correlation between sustainability being said sustainability directly related to GHG emission levels which states that the lower the GHG emission level the greater sustainability, wherein said sustainability characteristics comprises at least one of the following:
sustainability characteristics of the area of production of the raw material,
sustainability characteristics of the raw material-related data regarding GHG emission levels produced during production of raw material in the geographical area,
sustainability characteristics of the processing plant data regarding GHG emission levels produced in the processing plant where the raw material is transformed in bioproduct, and
sustainability characteristics related to logistics, from data regarding GHG emission levels produced in logistics associated to the carriage of the raw material and the distribution of the transformed bioproduct.

For the purpose of the invention the sustainability of the bioproduct is based on a mass-balance calculation of the final bioproduct or on a mass-balance calculation of the raw material to be transformed.

### PREFERRED EMBODIMENT OF THE INVENTION

The following example describes a preferred embodiment of the method object of the invention, in this example of non-limiting preferred embodiment, monitoring of sustainability of a final bioproduct fluid state comprises a common flow of a first and a second byproduct, for determine the sustainability of these, for it begins making a demarcation and establishment of a geographical area of origin of raw materials processed into bioproduct, optionally you can also proceed to define and establish a geographical area of plant location transformation of raw materials in bioproduct if deemed necessary, assign sustainability characteristics of the raw material from GHG emissions data generated during the production of raw materials, sustainability characteristics assigned to the processing plant from data GHG emissions generated during processing of the raw material byproduct, assign characteristics of sustainability associated logistics industry bioproducts industry which includes generation of raw materials, processing of this raw material and transportation byproduct from both production at the plant and from plant to distribution, and calculate the composition of the bioproduct end where the estimate includes data relating to quantities and second byproduct mixture of the first which make up that bioproduct final geographical areas are delimited and set using remote sensing techniques and further processing of these images.

In an alternative realization object of the invention, remote sensing techniques are supplemented with data and/or images taken from databases to supplement or replace those images captured in the event that the latter do not provide the necessary information before or after to processing.

To obtain data regarding the characteristics of sustainability is implemented an estimate of total emissions related to greenhouse gas emissions generated by partial each process or task assigned to both feedstock production and processing of the raw material and byproduct the associated logistics. These data can be obtained by collecting data directly or through acquisition of such data from databases to obtain the data once processed sustainability characteristics assigned respectively to the raw material from a GHG emissions data related to production raw material, with the transformation of the same and associated with the logistics.

The method described here covers both emissions associated with producing raw materials for processing into bio-product such as bio-production processes involved in transforming raw material itself, carried out at the production plant, involving the first part measurement of GHG emissions related to:
The creation of the own energy consumption required in the production plants to carry out the processes necessary to transform the source material byproduct being produced in this energy in terms of electricity (partly self-consumed and exported) and CHP (combined heat and power) using steam NG (natural gas) as fuel. Also considered exhaust gas by its energy content.
The bio-conversion processes, along with the production processes needed to convert the source material in bioproducts and coproduct in common processes are identified as those prior to the preparation of the product and coproduct. Listed as: milling, mashing, cooking, liquefaction, fermentation, distillation, dehydration, treating furnace, a cogeneration unit, gas turbine, steam turbine, preparation of raw material, biomass pretreatment, separation of solids/liquids, gasification, cooling, gas cleaning, compression, reaction catalysis, enzymatic hydrolysis, selexol, transesterification, evaporation, mixing, drying, extraction, degumming, filtration, recovery, refining, purification, clarification, acid esterification, condensation, ventilation and correction.

Additionally the method described by this process may also consider on coproducts of bioproducts when associated with those processes necessary to obtain the coproduct of the production of byproduct in the sales conditions required (as granules and with a defined moisture). Such co-produced along with the byproduct can be pure waste products that result to obtain as byproduct or waste products can be some value as DDGS (Dried Distilled Grain with solubles) would need individual treatment as solid/liquid separation, evaporation, drying, pelletizing, or the co-product may have a valuable product produced with the byproduct. In both cases produce emissions and therefore should be considered.

We can consider different co-products, such as, inter alia: biofuels, bioliquids, biogas, chemicals, raw materials, renewable electricity, thermal energy renewable bioplastics, resins and CO2.

The end always byproduct has in its composition at least a byproduct resulting from the processing of the raw material, which has a number of defining characteristics of sustainability that are related to the geographic area, emissions in its production (including emissions in the production of raw materials and processing in bioproduct) and therefore may be obtained in many types of byproduct sustainability function as possibilities are that data, in this embodiment take a first and a second byproduct from a first and second geographical area and determining the final composition of byproduct mixture comprises calculating an amount both first and second byproduct in the mixture; also the end byproduct may be a mixture of a first and a second byproduct from a first and second floor and the determination of byproduct composition comprising an amount calculated first and second byproduct in the mixture or where the first and second respectively corresponding to byproduct sustainability characteristics of the raw material or where the first and second respectively corresponding to byproduct sustainability characteristics to the processing plant.

To carry out the calculation is necessary to apply the mass balance and calculate an amount of byproduct stream entering end and an amount of byproduct stream exiting an end distribution facility, when estimating the final bioproduct application performs a calculation by mass balance, taking into account that for any byproduct sustainability characteristics are related to emissions of greenhouse gases GHG produced during the processes and tasks related to bioproducts industry which includes generation of raw material, transformation of this raw material in bioproduct.

Finally we proceed to calculate the amounts of first and second byproduct bioproduct present in the final, and correlate each part of the first and second bioproduct with the sustainability characteristics of each in order to determine what amounts of first and second bioproduct and their characteristics sustainability are present in the byproduct stream final and can certify the origin and composition of the final bioproduct and distribute power effectively.

The method object of the invention can take into account emissions related to the logistics associated with both the production of raw material for processing and distribution of byproduct, but it is possible that this point is not of interest and therefore not included, leaving only the raw material production and their transformation into bioproduct.

The method object of the invention in its phase of defining and establishing a geographical area associated with raw materials can also identify geographic areas sustainable, through the following steps (some of them common to the very definition and establishment through geolocation or remote sensing areas):

a) capture information through georeferenced satellite imaging for the region studied, high, medium or low resolution, since at least one imaging system and database archives of images available on the official databases and/or auxiliary data selection used to facilitate analysis of the cover land use, or as a baseline layer in the region studied, for example, to assess the biodiversity that relates to protected areas,

b) analysis of land use, comprising the following steps:

b1) importation of satellite images in the image processing module, to proceed to its pre-processing of images in high, medium or low resolution images conditioning, in order to obtain a classification of land use that distinguishes the figures defined by the requirements of sustainability on a map, and the six categories used by the IPCC plus a seventh category of perennial crops in another map, and finally proceed with an image classification in order to obtain the classification of land use, identifying land cover for each area,

c) processing information, comprising the following steps:

c1) processing of information to identify land uses,

c2) processing of information protected figures identified

c3) comparison of the processed information to determine the land use areas that match and mismatch,

d) analysis process by documentary evidence, and

e) display the results.

This method provides information that can demonstrate compliance with the requirements of land use (high biodiversity, high carbon stocks and peat) in the study areas and changing land use according to the six categories used by the IPCC plus a seventh category (perennial crops) in the areas studied.

The aim of this method is to identify:
Areas that meet the sustainability requirements, hereinafter “Go Areas”.
Regions with no change in land use.

The method object of the invention fulfills the following conditions:
Uniformity and homogeneity: the process must be applied easily in any region and any other time range, obtaining comparable results. In order to be able to implement the method in new regions or time periods if needed.
Use of methodological standards were tested and characterized by the effectiveness of the process.

Additionally, the current method provides maps that use graphic evidence that complement some of the information with documentary evidence as required. The processes include a main stage:
Map development process where the data (satellite imagery or maps complement each other), and data are then analyzed, obtaining maps with information from land use compiled according to the criteria of land use. Carried out two procedures for different information processing on the data analyzed: on one hand processing for land use and on the other hand, a specific processing for figures protected.

The information processing compared, preferably polygon by polygon, or pixel by pixel, among others, for each area in two reference dates (the initial reference year and reference year end). The following results are obtained in this process:
An area map Go, and
Map to identify the land use change.

Areas on the map Go, all the regions meet the sustainability requirements for biodiversity and carbon stocks in peat lands. In parallel, the map of change of use of land, all the regions must be compiled on a map where they are identified by region, category changes.

Those regions coincide with NUT 3 or a lower level (or correspondence in GAUL or another administrative unit), which meets the requirements of sustainability and have no land use change are included in the list of Sources of sustainability. Note that “NUT” and “GAUL” are territorial systems of geographical division.

Some preferred aspects relating to steps a) to e) are explained in more detail below:

a) Information collection, review and verification of data:

This stage is advanced to:
Compile all necessary information from data sources available for the project in each region studied
Select only the appropriate sources to meet project requirements
Purchase or download the selected data
Take quality control.

a1) According to a preferred embodiment of the invention is obtained satellite imaging (e.g., purchased) from available sources.

Satellite images are selected for complete coverage of each study area and to represent the types of land use in reporting dates, start and end dates (date of generation of map). The selected images will be selected considering the combination of spatial resolution, spectral and radiometric is best to demonstrate the requirements of sustainability and quality requirements.

Satellite images are differentiated according to the resolution and temporal availability:

The low-resolution images must be downloaded to the date of initial referral and the final reference date (date comparison) in order to ensure maximum temporal coverage.

The images of high and medium resolution must be downloaded in two representative dates, the date of initial referral and the final reference date (date comparison).

The image selection between high, medium and low resolution are taken in order to meet sustainability requirements with the best quality possible. Multitemporal image analysis makes possible to represent the seasonal variation in the coverage of land use in the best shape possible, mainly by reducing cloudiness, fog, shadows, or the impact of coverage. Finally, the image must be downloaded and subject to validation of quality, meeting the data quality. The data validation records must be maintained. The results of the analysis process must be viewed in a report and the downloaded images should be stored in a database.

a2) We require a selection of ancillary data and images to make a comprehensive compilation of information. Preferably, auxiliary data is selected from geographic databases that pertain to official sources such as organizations or government agencies authorized officers on the subject, comprising such auxiliary data:
Mapping data comprising data support for image orthorectification process,
Thematic data include supporting data for the analysis of land use and
Biodiversity data may include information of support for the identification of areas of nature conservation.

These data are used as auxiliary supports to facilitate analysis of the cover land use, or as a baseline layer. For example, to assess the biodiversity that is related to protected areas. In the case of protected areas, the auxiliary information compiled for biodiversity is used directly in the official databases except for the processing required in order that this is compatible with the map information processing result to the figures land use. The final result of the selection of ancillary data for areas of nature conservation, we obtain a map of protected figures.

b) Analysis of land use: At this stage we analyze the images and classified through a standardized process, explained as follows. The same processes must be performed for the reference year initial and final comparative reference year.

b1) satellite images are imported into a software for captured digital image processing. There are mainly two types of resolution, any other resolution might be suitable too:
Data from low resolution, and
Data resolution medium/high.

1. Sustainability monitoring method of a final bioproduct consisting of a mixture of at least one first and one second bioproduct wherein the method comprises:
capturing geotagged images using a remote sensing system in a production area of raw material processed into bioproduct,
geolocating at least one processing plant raw bioproduct material,
image processing by at least one processing unit of the captured images, to define and establish the area of production of raw material to be transformed into bioproduct,
calculating data regarding GHG emission levels for each process related to raw material production and logistics and processing and logistics related to the transformed bioproduct respectively associated with each of these processes,
send data related to these levels of GHG emissions to at least one database accessible by the at least one processing unit,
establish sustainability characteristics of raw material, transformed bioproduct and associated logistics according to a definite correlation between sustainability and data regarding GHG emission levels which states that the lower level greater sustainability,
retrieving from the database:
the sustainability characteristics of the raw material-related data regarding GHG emission levels produced during production of raw material in the geographical area,
the sustainability characteristics of the processing plant data regarding GHG emission levels produced in the processing plant where the raw material is transformed in bioproduct, and
sustainability characteristics related to logistics, from data regarding GHG emission levels produced in logistics associated to the carriage of the raw material and the distribution of the transformed bioproduct,
assigning each bioproduct relevant sustainability characteristics depending on the geographical area of production of raw material from which it is produced, the processing plant where it was produced and used in the transportation logistics of raw material to the plant and final bioproduct distribution, and
determining by calculating the respective quantities of each first and second byproduct processed in the processing plant, and
calculate the composition of the final bioproduct where the calculation includes data relating to quantities of first and second mixed bioproduct as the relevant sustainability characteristics that make up each component of the final bioproduct.

2. The method of claim 1, further comprising recovering database images corresponding to the geographical area of production of raw materials for further processing along with the images captured.

3. The method of claim 1 wherein the remote sensing techniques include shooting satellite images using high and low resolution.

4. The method of claim 1 wherein geographical areas are delineated and set by mapping the images.

5. The method of claim 4 wherein the mapping is processed by at least one processing unit to conform the reference system and projection of interest.

6. The method of claim 1 wherein the final bioproduct is a mixture of at least one first and one second bioproduct from at least a first and second geographical area and the step of determining the final composition of bioproduct comprises calculating the amount of bioproducts in the mixture.

7. The method of claim 1 wherein the final bioproduct is a mixture of a first and a second bioproduct respectively from a first and a second processing plant the second being different from the first and the step of determining the final bioproduct composition comprises calculating a first quantity and second byproduct in the mixture.

8. The method of claim 1 wherein the final bioproduct is a mixture of a first and a second bioproduct respectively from a first and a second material being different from the first second and the step of determining the final bioproduct composition comprises calculating an amount of first and second byproduct in the mixture.

9. The method of claim 1 wherein the calculation of the composition of byproduct is performed by applying the final mass balance.

10. The method of claim 1 wherein the sustainability characteristics are related to emissions of greenhouse gases GHG produced during the processes and tasks related to bioproducts industry which includes generation of raw materials, processing of this raw material in bioproduct.

11. The method of claim 1 wherein the byproduct comprises a coproduct.

12. The method of claim 1 where the byproduct is a biofuel.

13. The method of claim 12 where the biofuel is bioethanol.

14. The method of claim 12 wherein the biofuel is biodiesel.

15. Computer program for monitoring sustanaibility of bioproducts, the program comprising instructions for:
retrieving data related to GHG emissions produced during the production of raw material to be transformed into bioproduct,
capturing geotagged images of at least one area where the raw material is produced,
processing said images in order to image processing by at least one processing unit of the captured images, to define and establish the area of production of raw material to be transformed into bioproduct,
calculating data regarding GHG emission levels for each process related to raw material production and logistics and processing and logistics related to the transformed bioproduct respectively associated with each of these processes,
establish sustainability characteristics of raw material, transformed bioproduct and associated logistics according to a definite correlation between sustainability and data regarding GHG emission levels which states that the lower level greater sustainability, wherein said sustainability characteristics comprises at least one of the following:
sustainability characteristics of the raw material-related data regarding GHG emission levels produced during production of raw material in the geographical area,
sustainability characteristics of the processing plant data regarding GHG emission levels produced in the processing plant where the raw material is transformed in bioproduct, and
sustainability characteristics related to logistics, from data regarding GHG emission levels produced in logistics associated to the carriage of the raw material and the distribution of the transformed bioproduct,
assigning each bioproduct relevant sustainability characteristics depending on the geographical area of production of raw material from which it is produced, the processing plant where it was produced and used in the transportation logistics of raw material to the plant and final bioproduct distribution, and
calculating the respective quantities of each first and second bioproduct processed in the processing plant, and the composition of the bioproduct end where the calculation includes data relating to quantities of first and second mixed bioproduct as the relevant sustainability characteristics that make up each component of the final bioproduct.

16. The computer program of claim 15 being run by a processing unit of a programable device being the program allocated on a physical data carrier.

17. The computer program of claim 15 being run by a processing unit of a programable device being the program allocated on database accesible by the processing unit.

18. The computer program of claim 17 wherein the database is allocated at a remote server.

19. A computer-implemented business model data management method comprising:
retrieving data related to GHG emissions produced during the production of raw material to be transformed into bioproduct and its transformation and associated logistics to both processes and any task involved,
defining and establish the area of production of raw material to be transformed into bioproduct,
locating data management rules related to sustainability level in the database; and,
correlating said sustainability level with a business object, wherein said business object is related to a business application associated to a bioproduct obtained from raw material, and
executing said located data management rules to represent said identified business object in a database for said business application.

20. The method of claim 19 wherein the rules related to sustainability level comprises characteristics of raw material, transformed bioproduct and associated logistics according to a definite correlation between sustainability being said sustainability directly related to GHG emission levels which states that the lower the GHG emission level the greater sustainability, wherein said sustainability characteristics comprises at least one of the following:
sustainability characteristics of the area of production of the raw material,
sustainability characteristics of the raw material-related data regarding GHG emission levels produced during production of raw material in the geographical area,
sustainability characteristics of the processing plant data regarding GHG emission levels produced in the processing plant where the raw material is transformed in bioproduct, and
sustainability characteristics related to logistics, from data regarding GHG emission levels produced in logistics associated to the carriage of the raw material and the distribution of the transformed bioproduct.

21. The method of claim 19 wherein the business model is related to a final market value of the produced bioproduct depending on the sustainability level of said bioproduct.

22. The method of claim 19 wherein the business object is related to a final market value of the produced bioproduct depending on the sustainability level of said bioproduct.

23. The method of claim 21 wherein the sustainability of the bioproduct is based on a mass-balance calculation of the final bioproduct.

24. The method of claim 21 wherein the sustainability of the bioproduct is based on a mass-balance calculation of the raw material to be transformed.
